(19) United States
(12) Patent Application Publication
(10) Pub. No.: US 2022/0036250 A1
(43) Pub. Date: Feb. 3, 2022

(54) METHOD AND DEVICE FOR TRAINING TREE MODEL

(71) Applicant: HUAKONG TSINGJIAO INFORMATION SCIENCE (BEIJING) LIMITED, Beijing (CN)

(72) Inventors: Guosai Wang, Beijing (CN); Xu He, Beijng (CN); Xiaoyu Fan, Beijing (CN); Kun Chen, Beijing (CN)

(21) Appl. No.: 17/372,921

(22) Filed: Jul. 12, 2021

(30) Foreign Application Priority Data
Jul. 30, 2020 (CN) 2020107646405

(51) Int. Cl. G06N 20/20; G06N 5/00; G06N 5/04

(52) U.S. Cl. CPC G06N 20/20; G06N 5/04; G06N 5/003

(57) ABSTRACT

A method and device for training a tree model based on a dataset are disclosed. The dataset comprises m pieces of sample data and m sample labels, each sample data comprises n features, the features and feature values in the dataset are ciphertexts, the method comprises: generating, for the dataset, candidate splits based on ciphertexts; partitioning, for each candidate split, the dataset into a left and right subset based on ciphertexts; calculating a partition coefficient of each candidate split based on the left and right subset obtained through partition for each candidate split; determining a feature in a target candidate split as an optimal feature, determining a threshold in the target candidate split as an optimal splitting value, the optimal feature and the optimal splitting value are ciphertexts; assigning the dataset to two child nodes of the current node based on the optimal feature and the optimal splitting value.

### RELATED APPLICATION

The present application claims the priority to Chinese Patent Application No.: 202010764640.5, filed Jul. 30, 2020, the content of which is hereby incorporated herein by reference in its entirety.

### TECHNICAL FIELD

The present disclosure relates to the technical field of computers, in particular to a method and device for training a tree model.

### BACKGROUND

A decision tree is a tree structure, wherein each internal node in the tree represents a judgment on an attribute, each branch represents an output of a judgment result, and each leaf node represents a classification result. The decision tree can be trained based on sample data. Using the trained decision tree, a correct classification result can be given for new data.

With the advent of the era of big data, the business data generated by users when using network services are gathered under the big data platform, among which sensitive information related to user identity confidentiality, account security and personal privacy inevitably exists, the life of users will be seriously harmed if this information is leaked.

Therefore, how to protect the privacy security of data when training decision trees is a problem to be urgently solved.

### SUMMARY

The present application discloses a method and device for training a tree model, and a computer readable storage medium, in the present application, the tree model is trained based on ciphertexts, so that the privacy security of data can be ensured.

A method for training a tree model is discloses in the present application. The method is used to train the tree model based on a dataset, and wherein the dataset comprises m pieces of sample data and m sample labels, each sample data comprises n features, and wherein the features and feature values in the dataset are ciphertexts, the method comprises the following steps: generating, for the dataset, candidate splits based on the ciphertexts, wherein each candidate split is consisting of a feature and a threshold corresponding to the feature; partitioning, for each candidate split, the dataset into a left subset and a right subset based on the ciphertexts; calculating a partition coefficient of each candidate split based on the left subset and the right subset obtained through partition for each candidate split; determining a feature in a target candidate split as an optimal feature, and determining a threshold in the target candidate split as an optimal splitting value, wherein the target candidate split is a candidate split whose partition coefficient satisfies a preset condition, and the optimal feature and the optimal splitting value are ciphertexts; assigning the dataset to two child nodes of the current node based on the optimal feature and the optimal splitting value; and performing the above steps on the two child nodes recursively until a stop condition is satisfied.

An apparatus configured to train a tree model is discloses in the present application. The apparatus is used to train the tree model based on a dataset, and wherein the dataset comprises m pieces of sample data and m sample labels, each sample data comprises n features, and wherein the features and feature values in the dataset are ciphertexts, the apparatus comprises: a split generation module, configured to generate, for the dataset, candidate splits based on the ciphertexts, wherein each candidate split is consisting of a feature and a threshold corresponding to the feature; a subset partitioning module, configured to partition, for each candidate split, the dataset into a left subset and a right subset based on the ciphertexts; a coefficient calculation module, configured to calculate a partition coefficient of each candidate split based on the left subset and the right subset obtained through partition for each candidate split; an optimal determination module, configured to determine a feature in a target candidate split as an optimal feature, and determine a threshold in the target candidate split as an optimal splitting value, wherein the target candidate split is a candidate split whose partition coefficient satisfies a preset condition, and the optimal feature and the optimal splitting value are ciphertexts; a data assignment module, configured to assign the dataset to two child nodes of the current node based on the optimal feature and the optimal splitting value; and a recursive execution module, configured to perform the above steps on the two child nodes recursively until a stop condition is satisfied.

A device for training a tree model is discloses in the present application. The device is used to train the tree model based on a dataset, and wherein the dataset comprises m pieces of sample data and m sample labels, each sample data comprises n features, and wherein the features and feature values in the dataset are ciphertexts, wherein, the device comprises a memory and one or more programs, the one or more programs is stored in the memory and is configured as by one or more of processors execute, and the one or more programs include an instruction for performing the following steps: generating, for the dataset, candidate splits based on the ciphertexts, wherein each candidate split is consisting of a feature and a threshold corresponding to the feature; partitioning, for each candidate split, the dataset into a left subset and a right subset based on the ciphertexts; calculating a partition coefficient of each candidate split based on the left subset and the right subset obtained through partition for each candidate split; determining a feature in a target candidate split as an optimal feature, and determining a threshold in the target candidate split as an optimal splitting value, wherein the target candidate split is a candidate split whose partition coefficient satisfies a preset condition, and the optimal feature and the optimal splitting value are ciphertexts; assigning the dataset to two child nodes of the current node based on the optimal feature and the optimal splitting value; and performing the above steps on the two child nodes recursively until a stop condition is satisfied.

A computer readable storage medium is disclosed in the present application. In the computer readable storage medium, an instruction is stored in the storage medium and is configured as by one or more of processors execute for performing the method for training a tree model mentioned above.

In the method for training a tree model disclosed in the present application, a tree model can be trained based on a dataset on the basis of ciphertexts. The feature and feature value in the dataset are ciphertexts, and for the dataset, candidate splits are generated based on the ciphertexts, and the feature in the candidate split whose partition coefficient satisfies preset condition is determined to be the optimal feature, and the threshold in the candidate split whose partition coefficient satisfies a preset condition is determined to be the optimal splitting value, and the optimal feature and the optimal splitting value are also ciphertexts. Through the embodiments of the present disclosure, during the training of the tree model, the data in plaintext in the dataset can not be exposed, and the optimal feature and the optimal splitting value in plaintext can also not be exposed, and the privacy security of the data can be ensured.

### BRIEF DESCRIPTION OF THE DRAWINGS

In order to illustrate the technical solutions of the embodiments of the present disclosure more clearly, a brief description will be given below on the drawings which is used in the detailed description of the embodiments of the present disclosure. It should be noted that, the drawings described below are merely some embodiments of the present disclosure, and those skilled in the art may obtain other drawings according to these drawings without any creative effort.

FIG. 1 shows a flow chart of a method for training a tree model in an embodiment of the present disclosure;

FIG. 2 shows a structural block diagram of an apparatus configured to train a tree model in an embodiment of the present disclosure;

FIG. 3 shows a block diagram of a device 800 configured to train a tree model in an embodiment of the present disclosure;

FIG. 4 shows a structural schematic diagram of a server in an embodiment of the present disclosure.

### DETAILED DESCRIPTION

The technical solutions in the embodiments of the present disclosure will be described in combination with the accompanying drawings. It should be noted that, the described embodiments are a part but not all of the embodiments of the present disclosure. Based on the embodiments in the present disclosure, all the other embodiments obtained by those skilled in the art without any creative labor shall all fall within the protection scope of the present disclosure.

Examples and aspects of various method and device/apparatus embodiments are disclosed below.

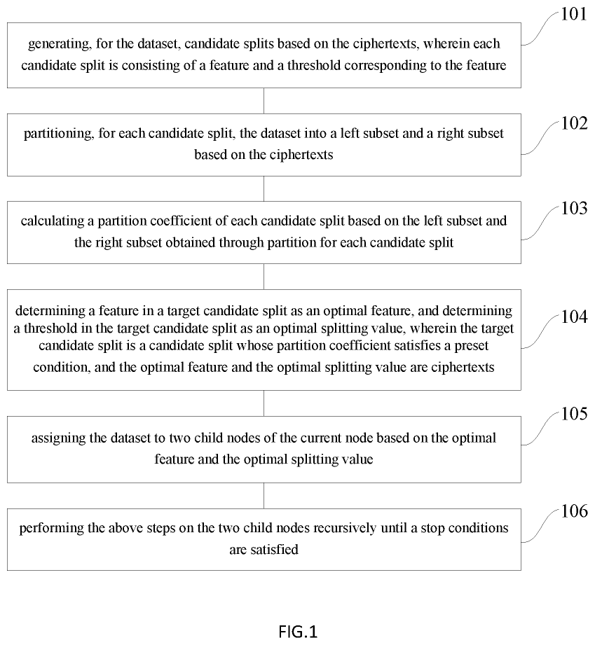

Please refer to FIG. 1 which shows a flow chart of a method for training a tree model in an embodiment of the present disclosure. The method is used for training the tree model based on a dataset, wherein the dataset includes m pieces of sample data and m sample labels, each sample data includes n features, the features and feature values in the dataset are ciphertexts, and the method includes the following steps.

Step 101, generating, for the dataset, candidate splits based on the ciphertexts, wherein each candidate split is consisting of a feature and a threshold corresponding to the feature.

Step 102, partitioning, for each candidate split, the dataset into a left subset and a right subset based on the ciphertexts.

Step 103, calculating a partition coefficient of each candidate split based on the left subset and the right subset obtained through partition for each candidate split.

Step 104, determining a feature in a target candidate split as an optimal feature, and determining a threshold in the target candidate split as an optimal splitting value, wherein the target candidate split is a candidate split whose partition coefficient satisfies a preset condition, and the optimal feature and the optimal splitting value are ciphertexts.

Step 105, assigning the dataset to two child nodes of the current node based on the optimal feature and the optimal splitting value.

Step 106, performing the above steps on the two child nodes recursively until a stop conditions are satisfied.

Embodiments of the present disclosure provide a method for training a tree model based on ciphertexts. The method is used for training a tree model based on a dataset, wherein the dataset includes m pieces of sample data and m sample labels, each sample data includes n features, and the features and feature values in the dataset are ciphertexts.

In one example, the dataset is represented by D(x,y). Wherein x is a sample data matrix with m rows and n columns. y is a one-dimensional vector containing m elements and is used for storing m sample labels.

Please refer to Table 1 which shows an example of a dataset D1 (x,y).

TABLE 1

| Arm length | Age | Weight | Healthiness |
|---|---|---|---|
| 0.5 | 21 | 70 | 0 |
| 0.7 | 5 | 20 | 1 |
| 0.9 | 7 | 30 | 0 |

As shown in Table 1, in the dataset D1(x,y), m=3, n=3. Wherein “arm length”, “age”, and “weight” are features of the sample data, “healthiness” is the sample label corresponding to the sample data, and each sample data corresponds to one sample label. The first column is the feature value corresponding to feature “arm length” of each sample data. The second column is the feature value corresponding to feature “age” of each sample data. The third column is the feature value corresponding to feature “weight” of each sample data. The fourth column is the sample label corresponding to each data item, with 0 indicating “unhealthy” and 1 indicating “healthy”.

Wherein,

$$x = \{ \begin{matrix}0.5 & 21 & 70 \\ 0.7 & 5 & 20 \\ 0.9 & 7 & 30\end{matrix} \} , y = [ 0 , 1 , 0 ]$$

It should be noted that in embodiments of the present disclosure, the features and feature values in the dataset are ciphertexts, and the sample labels can also be ciphertexts. That is to say, data shown in Table 1 are all ciphertexts. To facilitate description, data in the embodiments of the present disclosure are shown in plaintext.

In the embodiments of the present disclosure, the dataset is processed based on ciphertexts to train a tree model. The ciphertext-based operation can be implemented by a ciphertext computing system, and the ciphertext computing system is based on a multi-party secure computing protocol, and the data involved in the computation contains ciphertext data, and the intermediate results generated during the computation and the final computation results are also ciphertext data. In the ciphertext-based computing process, the data is not exposed in plaintext, thereby ensuring the privacy security of the data.

The ciphertext computing system performs calculation operations such as adding, subtracting, multiplying, dividing, averaging and the like on ciphertext data based on ciphertext computing protocols, performs comparison operation on ciphertext data, performs model training and predicting based on ciphertext data such as machine learning and artificial intelligence, and performs database query operations on ciphertext data, etc.

It should be noted that embodiments of the present disclosure do not limit the specific type of the ciphertext computing system. Different ciphertext computing systems can have different ciphertext computing protocols, and the ciphertext computing protocols can include any of the following: SS (Secret Sharing) based ciphertext computing protocol, GC (Garble Circuit) based ciphertext computing protocol, and HE (Homomorphic Encryption) based ciphertext computing protocol.

The process of training a tree model based on a dataset on the basis of a ciphertext in an embodiment of the present disclosure is as follows.

First, for the dataset, candidate splits are generated based on ciphertexts, and the candidate split is represented as θ=(j, tₘ), and each candidate split consists of a feature (represented as feature j) and a threshold (represented as tₘ) corresponding to the feature. For each candidate split, the dataset is partitioned into a left subset D_{left} and a right subset D_{right}, wherein,

D_{left}(θ)=(x,y)|xⱼ≤tₘ (1)

D_{right}(θ)=D\D_{left}(θ) (2)

Then, based on the left subset and the right subset obtained through partitioning for each candidate split, a partition coefficient of each candidate split is calculated. The partition coefficient is used to measure the classification effect of the candidate split.

In an optional embodiment of the present disclosure, the partition coefficient is a Gini index, the Gini index is calculated based on an impurity function, and the impurity function includes a Gini function or an Entropy function.

In an embodiment of the present disclosure, the Gini index is calculated by the following equation:

$$G ( D , θ ) = \frac{{n}_{left}}{{N}_{m}} H ( {D}_{left} ( θ ) ) + \frac{{n}_{right}}{{N}_{m}} H ( {D}_{right} ( θ ) ) \qquad ( 3 )$$

Wherein G(D, θ) represents the Gini index of the candidate split θ on the dataset D, and the H function is the impurity function. n_{left} represents the number of sample data in the left subset D_{left}, n_{right} represents the number of sample data in the right subset D_{right}, and Nₘ represents the total number of sample data in the dataset D. The H function is the impurity function, which includes the Gini function and the Entropy function. The Gini function is:

H(Q)=Σₖpₖ(1−pₖ) (4)

The Entropy function is:

H(Q)=−Σₖpₖ log(pₖ) (5)

Wherein,

pₖ=1/NΣxᵢ∈QI(yᵢ=k) (6)

In equations (4), (5) and (6), k takes the values of 0, 1.

The smaller the Gini index is, the better the classification effect is. Therefore, when the partition coefficient is Gini index, a candidate split with the smallest Gini index is determined as the target candidate split that satisfies the preset condition. It should be noted that, embodiments of the present disclosure do not limit the type of partition coefficients. For example, in addition to Gini index, information gain can also be used as the partition coefficient, and the larger the information gain is, the better the classification result is. Therefore, when the partition coefficient is the information gain, a candidate split with the greatest information gain is determined as the target candidate split that satisfies the preset condition. Or, when the partition coefficient is the information gain, the opposite of the information gain can be taken, and the smaller the opposite is, the better the classification result is, and at this time, the candidate split with the smallest opposite is determined as the target candidate split that satisfies the preset condition.

To facilitate description, in embodiments of the present disclosure, the partition coefficient is the Gini index. And then, the feature in the candidate split with the smallest Gini index is determined as the optimal feature, and the threshold in the candidate split with the smallest Gini index is determined as the optimal splitting value, wherein the optimal feature and the optimal splitting value are ciphertexts.

The optimal splitting value is represented as θ*, and is represented by the following equation:

θ*=argmin_{θ}G(D,θ) (7)

Wherein, the argmin function is a function defined in the ciphertext computing system, and is used to determine the minimum value among multiple ciphertext data. The candidate split with the smallest Gini index is determined through equation (7), the feature in the determined candidate split is the optimal feature of the current node, and the threshold corresponding to the feature in the determined candidate split is the optimal splitting value of the current node. The optimal feature and the optimal splitting value are ciphertexts.

After the optimal feature and the optimal splitting value are determined, the dataset is assigned to two child nodes of the current node based on the optimal feature and the optimal splitting value.

Specifically, as to the current node, two child nodes of the current node are generated, and the sample data in the dataset is assigned to the two child nodes of the current node based on the optimal feature and the optimal splitting value. It should be noted that this step is also performed on the basis of ciphertexts.

Finally, when the above steps are performed recursively on the two child nodes until the stop condition is satisfied, the training process of the tree model is completed, and the final tree model is obtained.

The nodes in the tree model include a root node, internal node, and leaf node. Each node stores information about the node, such as the sample data associated with the node, the height of the node. The root node and the internal node store the optimal feature and the optimal splitting value selected for dataset partition or node splitting, while the leaf node records the corresponding label value for which they are labeled.

In the embodiments of the present disclosure, the optimal feature and the optimal splitting value in the tree model are stored in ciphertexts. For example, in an internal node, “height” is selected as the optimal feature, and the feature value of the height being “160” is selected as the optimal splitting value, then the optimal feature “height” and the optimal splitting value “160” stored in the internal node are both ciphertexts. Other information can be stored in plaintext (such as the height of the node, etc.). With this, in the process of training the tree model in embodiments of the present disclosure, the original data in the dataset will not be leaked, and the privacy security of the data can be ensured.

In an embodiment of the present disclosure, the stop condition includes any one of the following: the depth of a tree model being constructed currently reaches a preset maximum depth, the number of features in the child nodes is less than a preset minimum number, and all the sample data in the dataset are assigned.

In an implementation, the process for training the tree model includes: inputting the dataset and stop condition, performing recursion operation on each node from the root node according to the dataset to construct a tree model, and outputting the tree model when the stop condition is satisfied.

It should be noted that the above stop condition is merely an example of an embodiment of the present disclosure, and the stop condition can be set flexibly according to requirements in practical applications. For example, the following stop condition can also be set: the uncertainty of the current node about the label category is less than or equal to the preset minimum uncertainty, and the value of the uncertainty is in the range of [0,1].

In an embodiment of the present disclosure, the step of generating, for the dataset, candidate splits based on ciphertexts in step 101 includes:

step S11, sorting, in a preset sorting manner, the m feature values corresponding to the j-th feature in the dataset based on the ciphertext, to obtain a first array corresponding to the j-th feature, with j taking a value in a range from 0 to n−1.

S12, for the j-th feature, selecting in sequence an element from the first array as a threshold corresponding to the j-th feature, and combining the threshold with the j-th feature to obtain a candidate split.

As to the candidate split θ=(j, tₘ), j takes a value in the range of 0 to n−1. In particular, for the j-th feature, tₘ takes a value among the m feature values corresponding to the j-th feature, or, after the m feature values corresponding to the j-th feature are sorted, tₘ takes the average of the neighboring feature values after sorting is taken. In the embodiment of the present disclosure, tₘ taking a value from the m feature values corresponding to the j-th feature is taken as an example.

To facilitate description, a dataset D2(x,y) containing only one feature is taken as an example, and let's suppose m=10 and n=1. Wherein x=[99, 89, 69, 50, 95, 98, 92, 91, 85, 85], y=[1,1,0,0,0,1,1,1,1,1]. Since D2(x,y) contains only one feature, j has only one value, i.e., j=0. In this example, the m feature values corresponding to the j-th (j=0) feature can be represented as xⱼ=[99,89,69,50,95,98,92,91,85,85].

The m (m=10) feature values corresponding to the j-th (j=0) feature in the dataset D2(x,y) are sorted in a preset sorting manner based on the ciphertext, to obtain the first array corresponding to the j-th feature, and the first array is supposed to be represented as xⱼ₁. The preset sorting manner can be from smallest to largest or from largest to smallest, with the sorting manner being from smallest to largest as an example,

xⱼ₁=[50,69,85,85,89,91,92,95,98,99]. It should be noted that the values in x, y, xⱼ, and xⱼ₁ are all ciphertexts.

Next, for the j-th feature, an element is selected in sequence from the first array as the threshold corresponding to the j-th feature, and the threshold is combined with the j-th feature to obtain a candidate split.

Specifically, for the first time, the 0th element is selected from the first array as the threshold corresponding to the j-th (j=0) feature, and is combined with the j-th (j=0) feature to obtain the candidate split (0.50). For the second time, the 1th element is selected from the first array as the threshold corresponding to the j-th (j=0) feature, and is combined with the j-th (j=0) feature to obtain the candidate split (0.69). For the third time, a 2th element is selected from the first array as the threshold corresponding to the j-th (j=0) feature, and is combined with the j-th (j=0) feature to obtain the candidate split (0.85). And so on until the (m−1)th element is selected from the first array as the threshold corresponding to the j-th (j=0) feature and is combined with the j-th (j=0) feature to obtain the candidate split (0.99).

However, during practical applications, if the maximum value in the first array is selected as the threshold, i.e., the obtained candidate split is (0.99), the dataset D2(x,y) is partitioned according to this candidate split, since the dataset D2(x,y) contains no feature value greater than 99, the right subset is empty. To avoid this, in the embodiment of the present disclosure, during generating candidate splits, the maximum value in the first array is prevented from being selected as the threshold.

In an embodiment of the present disclosure, the step of selecting in sequence an element from the first array as the threshold corresponding to the j-th feature includes: selecting in sequence an element from the non-maximum elements in the first array as the threshold corresponding to the j-th feature.

In the above example, excluding the maximum value in the first array, the number of the threshold values is m−1=9. During generating the candidate splits, the 0th element to the (m−2)th element in xⱼ₁ are selected in sequence as the threshold corresponding to the j-th feature, and are combined with the j-th feature to obtain the candidate splits. That is, the generated candidate splits include: (0.50), (0.69), (0.85), . . . , (0.98), 9 candidate splits in total.

In an embodiment of the present disclosure, after obtaining the first array corresponding to the j-th feature, the method further includes determining a second array corresponding to the first array according to the same sorting manner as used in the m feature values corresponding to the j-th feature, wherein the second array includes each sample label corresponding to each feature value in the first array.

And the step of partitioning the dataset into a left subset and a right subset based on the ciphertexts for each candidate split in step 102 includes: based on the feature and threshold in each candidate split, partitioning the m pieces of sample data into a left subset and the right subset and partitioning the second array to the left subset and the right subset.

Still with the above example as an example, after the j-th features of x in the dataset D2(x,y) are sorted in an order from smallest to largest to obtain xⱼ₁=[50,69,85,85,89,91,92,95,98,99], a second array corresponding to the first array is determined in the same order as used in the m feature values corresponding to the j-th feature, and the second array includes sample label corresponding to each feature value in the first array. The second array is represented as yⱼ, yⱼ=[0,0,1,1,1,1,1,0,1,1]. Wherein the feature values in xⱼ₁=[50,69,85,85,89,91,92,95,98,99] are in one-to-one correspondence with the sample labels in yⱼ=[0,0,1,1,1,1,1,0,1,1].

Based on the feature and threshold in each candidate split, the m pieces of sample data in the dataset D2(x,y) are partitioned into a left subset D_{left} and a right subset D_{right}, and the second array is partitioned to the left subset D_{left} and the right subset D_{right}.

In this example, the candidate split (0.91) is taken as an example. For the candidate split, the sample data with the feature value of the 0th feature being less than or equal to 91 is partitioned into the left subset D_{left}, and then the feature values in the left subset D_{left} take the values of j_{left}=[50,69,85,85,89,91]. The sample data with the feature value of the 0th feature being greater than 91 is partitioned into the right subset D_{right}, and then the feature values in the right subset D_{right} take the values of j_{right}=[92,95,98,99]. The second array is partitioned into the D_{left} and right subset D_{right}, specifically, according to the sample data partitioned into the left subset D_{left} and right subset D_{right}, the sample labels in the second array are partitioned to corresponding left subset D_{left} or right subset D_{right}. For example, the sample labels partitioned to the left subset D_{left} take the value of y_{j-left}=[0,0,1,1,1,1], and the sample labels partitioned to the right subset D_{right} take the value of y_{j-right}=[1,0,1,1]. Among them, the feature values in j_{left}=[50,69,85,85,89,91] are in one-to-one correspondence with the sample labels in y_{j-left}=[0,0,1,1,1,1]. The feature values in j_{right}=[92,95,98,99] are in one-to-one correspondence with the sample labels in y_{j-right}=[1,0,1,1].

According to the same method, for the above nine candidate splits, the m pieces of sample data in the dataset D2(x,y) are partitioned into a left subset and a right subset, and the corresponding second array is partitioned to the left subset and the right subset, respectively.

It should be noted that, in the above examples, the dataset D2(x,y) is described as a dataset containing only one feature (n=1) in order to simplify the description. In practical applications, when n is greater than 1, the m feature values corresponding to each of the n features need to be sorted to obtain the candidate split corresponding to each feature.

With the dataset D1(x,y) shown in Table 1 as an example, m=3, n=3, the value range of j is from 0 to n−1, that is, the value range of j is from 0 to 2. First, the 0th feature “arm length” is selected, then j=0, xⱼ=[0.5, 0.7, 0.9], after xⱼ are sorted from smallest to largest, xⱼ₁=[0.5, 0.7, 0.9] and the corresponding second array yⱼ=[0, 1, 0] are obtained. For the 0th feature, the possible values of the threshold tₘ are 0.5 and 0.7 (excluding the maximum value 0.9), and the following candidate splits are obtained: (0, 0.5), (0, 0.7). For the candidate split (0, 0.5), the three sample data in the dataset D1(x,y) are partitioned into a left subset and a right subset, and the second array yⱼ=[0,1,0] is correspondingly partitioned to the left subset and the right subset. For the candidate split (0,0.7), the three sample data in the dataset D1(x,y) are partitioned into a left subset and a right subset, and the second array yⱼ=[0,1,0] is correspondingly partitioned to the left subset and the right subset.

Then the first feature “age” is selected, then j=1, xⱼ=[21, 5, 7], after xⱼ are sorted from smallest to largest, xⱼ₁=[5, 7, 21] and the corresponding second array yⱼ=[1,0,0] are obtained. For the first feature, the possible values of the threshold tₘ are 5 and 7 (excluding the maximum value 21), and the following candidate splits are obtained: (0.5), (0.7). For the candidate split (0.5), the three sample data in the dataset D1(x,y) are partitioned into a left subset and a right subset, and the second array yⱼ=[0,1,0] is correspondingly partitioned to the left subset and the right subset. For the candidate split (0.7), the three sample data in the dataset D1(x,y) are partitioned into a left subset and a right subset, and the second array yⱼ=[0,1,0] is correspondingly partitioned to the left subset and the right subset.

Finally, the second feature “weight” is selected, then j=2, xⱼ=[70, 20, 30], after xⱼ are sorted from smallest to largest, xⱼ₁=[20, 30, 70] and the corresponding second array yⱼ=[1,0,0] are obtained. For the second feature, the possible values of the threshold tₘ are 20 and 30 (excluding the maximum value 70), and the following candidate splits are obtained: (0.20), (0.30). For the candidate split (0.20), the three sample data in the dataset D1(x,y) are partitioned into a left subset and a right subset, and the second array yⱼ=[0,1,0] is correspondingly partitioned into the left subset and the right subset. For the candidate split (0.30), the three sample data in the dataset D1(x,y) are partitioned into a left subset and a right subset, and the second array yⱼ=[0,1,0] is correspondingly partitioned to the left subset and the right subset.

After the dataset is partitioned into a left subset and a right subset based on the ciphertext for each candidate split, the partition coefficient of each candidate split is calculated based on the left subset and the right subset obtained through partition for each candidate split according to equation (3).

Still with the example of the above dataset D2(x,y) as an example, suppose that the partition coefficient of the candidate split (0.91) is calculated. The values of the feature values in the left subset D_{left} obtained through partition for the candidate split (0.91) are j_{left}=[50,69,85,85,89,91], the values of the sample labels in the left subset D_{left} are y_{j-left}=[0,0,1,1,1,1], the values of the feature values in the right subset D_{right} are j_{right}=[92,95,98,99], and the values of the sample labels in the right subset D_{right} are y_{j-right}=[1,0,1,1].

It can be known according to the equation (3) that, firstly, the value of the H function on D_{left} and D_{right} is calculated respectively. For D_{left}, y_{j-left}=[0,0,1,1,1,1], and k takes the value of 0 or 1, then

p₀=⅙ sum(y_{j-left}==0)=⅓

p₁=⅙ sum(y_{j-left}==1)=⅔

Wherein the sum algorithm is the summation operation on the ciphertext vector elements in the ciphertext computing system.

$$H ( {D}_{left} ) = {\sum }_{k} {p}_{k} ( 1 - {p}_{k} ) = {p}_{0} * ( 1 - {p}_{0} ) + {p}_{1} * ( 1 - {p}_{1} ) = \frac{4}{9}$$

Similarly, the follow is obtained:

H(D_{right})=⅜

According to equation (3), the Gini index of the candidate split (0.91) is calculated as:

$$G ( D , θ ) = \frac{{n}_{left}}{{N}_{m}} H ( {D}_{left} ( θ ) ) + \frac{{n}_{right}}{{N}_{m}} H ( {D}_{right} ( θ ) ) = \frac{6}{10} * \frac{4}{9} + \frac{4}{10} * \frac{3}{8} = \frac{5}{12}$$

Through the same method, the partition coefficient (Gini index) of each candidate split of the dataset D2(x,y) is calculated.

For the dataset D2(x,y), since only one feature (the 0th feature) is contained, the feature is the optimal feature. The partition coefficients respectively corresponding to the 9 candidate splits are calculated, and the candidate split with the smallest partition coefficient is determined as the target candidate split. The threshold in the target candidate split is selected as the optimal splitting value. Suppose that the partition coefficient of the candidate split (0.85) obtained through calculation is the smallest, the candidate split (0.85) is the target candidate split, and the threshold “85” in the target candidate split is selected as the optimal splitting value.

For the dataset D1(x,y), three features are contained, the partition coefficient of each feature corresponding to each candidate split are calculated respectively, and the candidate split with the smallest partition coefficient is determined as the target candidate split. The feature in the target candidate split is selected as the optimal feature, and the threshold in the target candidate split is selected as the optimal splitting value. Suppose that the partition coefficient of the candidate split (0,0.7) obtained through calculation is the smallest, then the candidate split (0,0.7) is the target candidate split, the feature (the 0th feature) in the target candidate split is determined as the optimal feature, and the threshold (0.7) in the target candidate split is determined as the optimal splitting value. In other words, the feature “arm length” is determined as the optimal feature, and the feature value “0.7” corresponding to the feature “arm length” is determined as the optimal splitting value.

In an embodiment of the present disclosure, the step of determining the feature in a target candidate split as an optimal feature, and determining a threshold in the target candidate split as an optimal splitting value in step 104 includes the following steps.

Step S21, constructing a first matrix with n rows and m−1 columns based on the partition coefficient of each candidate split.

Step S22, constructing a second matrix with n rows and m−1 columns based on the sorting results of m feature values corresponding to each feature in the dataset.

Step S23, transforming the first matrix into a first vector.

Step S24, determining the ciphertext index corresponding to the element whose partition coefficient satisfies the preset condition in the first vector.

Step S25, determining the optimal feature based on the ciphertext index, and determining the optimal splitting value based on the ciphertext index and the second matrix.

Since the feature and threshold in each candidate split are ciphertexts, and the data in the dataset are also ciphertexts, in the embodiment of the present disclosure, the target candidate splits are determined and the optimal feature and the optimal splitting value in the target candidate split are obtained through constructing a matrix and performing the ciphertext operation between the matrixes.

Specifically, a first matrix with n rows and m−1 columns is first constructed based on the partition coefficient of each candidate split, the first matrix is represented as M. The first matrix is used to store the partition coefficient corresponding to each candidate split. Wherein m is the number of rows of the sample data matrix x in the dataset D(x,y), and n is the number of columns of x.

A second matrix with n rows and m−1 columns, which is represented as x2, is constructed based on the sorting results of the m feature values corresponding to each feature in the dataset D(x,y). The second matrix is used to store the feature values after sorting the sample data matrix x based on feature. Row i in x2 stores the 0th to (m−2)th feature values of the j-th features in x after the j-th features are sorted from smallest to largest. Wherein i takes a value in the range of 0 to m−1 and j takes a value in the range of 0 to n−1.

After the m feature values corresponding to the j-th feature of the dataset D(x,y) are sorted to obtain the first array xⱼ₁ corresponding to the j-th feature and the second array yⱼ corresponding to xⱼ₁, the 0th to (m−2)th elements in xⱼ₁ can all be used as the threshold tₘ. With D2(x,y) as an example, 9 values of tₘ can be available, i.e., 9 candidate splits are available, then the partition coefficients respectively corresponding to these 9 candidate splits are filled into the first matrix M in sequence.

Next, the first matrix M is transformed into a one-dimensional first vector based on the flatten function in the ciphertext computing system, and then the ciphertext index corresponding to the element whose partition coefficient satisfies the preset condition is determined in the first vector based on the ciphertext computing function in the ciphertext computing system. When the partition coefficient is Gini index, the ciphertext index corresponding to the element with the smallest partition coefficient is determined in the first vector through the ciphertext computing function argmin, and the ciphertext index is represented as s, then

s=argmin(M·flatten( )) (8)

It should be noted that when the partition coefficient is an information gain, the ciphertext index corresponding to the element with the largest partition coefficient is determined in the first vector through the ciphertext computing function argmax.

In the embodiment of the present disclosure, the index of the element whose partition coefficient satisfies the preset condition in the first vector is also ciphertext, thus, the possibility of data leakage can be reduced and the privacy security of data can be improved.

Finally, the optimal feature is determined based on the ciphertext index, and the optimal splitting value is determined based on the ciphertext index and the second matrix.

In an embodiment of the present disclosure, the step of determining the optimal feature based on the ciphertext index includes the following steps.

Step S31, performing an exact division operation on n by using the ciphertext index, to obtain the target index of the optimal feature in the n features.

Step S32, determining the optimal feature in the n features according to the target index.

In an embodiment of the present disclosure, the target index Iⱼ of the optimal feature in the n features is calculated by the following equation:

Iⱼ=s//n=pnp·floor(s/n) (9)

Equation (9) represents that an exact division operation is performed on n (n is the number of features, i.e., the number of columns of the sample data matrix x) by using the ciphertext index s, to obtain the target index of the optimal feature in the n features. Wherein, the pnp.floor function represents that the ciphertext floating point number are rounded down.

In an example, suppose that the sample data matrix x in the dataset D3(x,y) contains 10 sample data (m=10), and each sample data contains 3 features (n=3), i.e., x is a matrix with 10 rows and 3 columns. A candidate split of the dataset D3(x,y) is generated on the basis of ciphertext, and the partition coefficient of each candidate split is calculated based on a left subset and a right subset obtained through partitioning the dataset D3(x,y) for each candidate split, and a first matrix M of n rows and m−1 columns is constructed according to the partition coefficient of each candidate split, and M is a matrix of 3 rows and 9 columns. Each row of M represents the partition situation of the candidate split corresponding to one feature in the dataset D3(x,y). In the example, x in dataset D3(x,y) contains 10 sample data, so m−1=9 possible values are available for the threshold tₘ corresponding to each feature.

Since the first matrix M is a matrix with 3 rows and 9 columns and includes 27 elements, after the first matrix M is transformed into a one-dimensional first vector, the first vector also contains 27 elements. In the first vector, the 0th to the 8th elements represent the partition situation of the candidate split corresponding to the 0th feature, the 9th to the 17th elements represent the partition situation of the candidate split corresponding to the 1th feature, and the 18th to the 26th elements represent the partition situation of the candidate split corresponding to the 2th feature.

According to equation (8), the ciphertext index s corresponding to the element with the smallest partition coefficient is determined in the first vector. The target index Iⱼ of the optimal feature in n features is obtained by substituting the ciphertext index s into equation (9). It can be known through equation (9) which row should the target index Iⱼ be located in the first matrix if the first vector is transformed to the form of a two-dimensional first matrix (a matrix of 3 rows and 9 columns). For example, suppose that the ciphertext index s=13, then the target index Iⱼ=s//9=1, that is, the target index Iⱼ is in the first row of the first matrix M, so the optimal feature that should be selected by the current node is the 0th feature. It should be noted that the values of the above ciphertext index s and target index Iⱼ are all ciphertexts.

In an embodiment of the present disclosure, the step of determining the optimal splitting value based on the ciphertext index and the second matrix includes the following steps.

Step S41, constructing a first sequence, wherein the first sequence is a sequence of integers starting from 0 to (m−1)×n.

Step S42, comparing the ciphertext index with each element in the first sequence, respectively, to obtain an index vector consisting of the comparison results represented by ciphertexts.

Step S43, transforming rows 0 to m−2 of the second matrix into a second vector.

Step S44, performing an inner product operation on the second vector and the index vector to obtain the optimal splitting value.

Without exposing the data in plaintext, in the embodiments of the present disclosure, the optimal splitting value is determined based on the constructed matrix and a ciphertext operation between the matrixes.

Specifically, a first sequence is first constructed, wherein the first sequence is a sequence of integers starting from 0 to (m−1)×n. With the sample data matrix x in the above dataset D3(x,y) as an example, wherein m=10 and n=3, the first sequence index1 is constructed, and then index1=[0,1,2, . . . ,25,26]. The values in the first sequence are ciphertexts.

The ciphertext index s is compared with each element in the first sequence index1 respectively to obtain an index vector consisting of the comparison results represented by ciphertexts. It should be noted that the comparison operation is a ciphertext-based comparison operation. Each element of the index vector represents a comparison result, and the comparison result is represented by a 0-1 vector, i.e., each element is a ciphertext of 0 or a ciphertext of 1.

Next, the second matrix x2 is transformed into a one-dimensional second vector, and is represented as x3, then

x3=x2·flatten( ) (10)

Wherein the flatten( ) function is used to transform the matrix x2 into a one-dimensional vector.

Finally, the optimal splitting value is obtained by performing an inner product operation on the second vector and the index vector, and the optimal splitting value is represented as a, then

a=inner(x3,S) (11)

Wherein the inner function is a function defined in the ciphertext computing system and is used to perform inner product operations based on ciphertexts.

In an embodiment of the present disclosure, the tree model includes any of the following: a CART model, a random forest model, and an XGBoost model.

Wherein, the CART (Classification And Regression Trees) model is used for both classification and regression tasks. Compared with ID3 and C4.5 which can only be used for discrete data and only for classification task, the CART algorithm has a much wider applicability and can be used for both discrete and continuous data, and can handle both classification and regression tasks.

The random forest model and XGBoost (eXtreme Gradient Boosting, integrated tree model) are based on integrated learning algorithms, and the base learners are both decision trees. Since random forest and XGBoost can be regarded as a combination of multiple CART decision trees, embodiments of the present disclosure are illustrated with CART decision tree as an example.

In an embodiment of the present disclosure, the tree model is a CART model, and the step of assigning the dataset to two child nodes of the current node based on the optimal feature and the optimal splitting value includes the following steps.

Step S51, determining the column vector corresponding to the optimal feature in the dataset.

Step S52, comparing the optimal splitting value with each element in the column vector, respectively, to obtain a result matrix consisting of the comparison results represented by ciphertexts.

Step S53, restoring each element in the result matrix to plaintext to obtain a result matrix represented by plaintexts.

Step S54, assigning the sample data corresponding to the element of the first value in the result matrix represented by plaintexts and the sample label corresponding to the sample data to the left node of the current node, and assigning the sample data corresponding to the element of the second value in the result matrix represented by plaintexts and the sample label corresponding to the sample data to the right node of the current node.

After the optimal feature and the optimal splitting value are determined, two child nodes are generated with the current node as a parent node, and the dataset is assigned to the two child nodes of the current node based on the optimal feature and the optimal splitting value. The above steps are performed recursively on the two child nodes until the stop condition is satisfied, then the training for the tree model is completed.

Since the optimal feature and the optimal splitting value are ciphertexts, and the sample data and the sample labels in the dataset are also ciphertexts, in the embodiments of the present disclosure, on the basis of the ciphertexts, the dataset is assigned to two child nodes of the current node according to the optimal feature and the optimal splitting value.

Specifically, the column vector corresponding to the optimal feature in the dataset is first determined. Suppose that the determined optimal feature is the t-th feature, the optimal splitting value is the feature value a of the t-th feature, and both t and a are ciphertexts. In the embodiment of the present disclosure, the column vector corresponding to the optimal feature (the t-th feature) is firstly selected from the sample data matrix x of the dataset D(x,y).

In an example, with the dataset D4(x,y) as an example, suppose that the sample data matrix x is a matrix with 2 rows and 3 columns, which is specifically as follows:

$$x = \{ \begin{matrix}1 & 2 & 3 \\ 4 & 5 & 6\end{matrix} \}$$

Suppose that the first feature in the sample data matrix x is the optimal feature, the column vector corresponding to the optimal feature in the dataset D4(x,y) is first determined and is represented as:

$$C = \{ \begin{matrix}2 \\ 5\end{matrix} \}$$

Through the previous steps, suppose that the optimal feature (the first feature) has been determined based on the ciphertext index, and that the optimal splitting value has been determined based on the ciphertext index and the second matrix (suppose that the optimal splitting value is that the feature value of the first feature, that is a=1), the optimal splitting value is compared with each element of the column vector C to obtain a result matrix composed of the comparison results represented by ciphertexts. It should be noted that the comparison operation is a ciphertext-based comparison operation. Each element in the index vector represents a comparison result, and the comparison result is represented by a 0-1 vector, i.e., each element is a ciphertext of 0 or a ciphertext of 1.

In the above example, the optimal splitting value is a=1, the column vector corresponding to the optimal feature is C, and the optimal splitting value is compared with each element of the column vector to obtain the result matrix r composed of the comparison results represented by ciphertexts, then

$$r = ( C == a ) = \{ \begin{matrix}0 \\ 0\end{matrix} \}$$

Next, each element of the result matrix is restored to plaintext to obtain the result matrix represented by plaintexts, the sample data corresponding to the element of the first value in the result matrix represented by plaintexts and the sample label corresponding to that sample data are assigned to the left node of the current node, and the sample data corresponding to the element of the second value in the result matrix represented by plaintexts and the sample label corresponding to the sample data are assigned to the right node of the current node.

With the first value being 1 and the second value being 0 as an example, the sample data corresponding to the element with a value of 1 in the result matrix represented by plaintexts and the sample label corresponding to the sample data are assigned to the left node of the current node, and the sample data corresponding to the element with a value of 0 in the result matrix represented by plaintexts and the sample label corresponding to the sample data are assigned to the right node of the current node.

In an embodiment of the present disclosure, the step of determining the column vector corresponding to the optimal feature in the dataset includes the following steps.

Step S61, constructing a second sequence, wherein the second sequence is a sequence of integers starting from 0 to n−1.

Step S62, comparing the ciphertext index with each element in the second sequence, respectively, to obtain a third vector consisting of the comparison results represented by ciphertexts.

Step S63, extending the third vector by m−1 rows to obtain a comparison matrix.

Step S64, multiplying the comparison matrix with a sample data matrix of m rows and n columns to obtain a third matrix.

Step S65, adding together the third matrix by columns to obtain the column vector corresponding to the optimal feature.

In the embodiments of the present disclosure, based on ciphertext operation between the matrixes, the column vector corresponding to the optimal feature (the t-th feature) in the dataset is determined, i.e., the t-th column is selected form the sample data matrix x of the dataset D(x,y).

First, a second sequence is constructed, and the second sequence is a sequence of integers starting from 0 to n−1. With the sample data matrix x in the above dataset D4(x,y) as an example, wherein m=2, n=3, the second sequence index2 is constructed, then index2=[0, 1, 2]. The values in the second sequence are ciphertexts.

The ciphertext index s is compared with each element of the second sequence index2, to obtain a third vector composed of the comparison results represented by ciphertexts. It should be noted that the comparison operation is a ciphertext-based comparison operation. Each element of the index vector represents a comparison result, and the comparison result is represented by a 0-1 vector, i.e., each element is a ciphertext of 0 or a ciphertext of 1.

With the ciphertext index s is a ciphertext of “1” as an example, the ciphertext index s is compared with each element in the second sequence index2, to obtain a third vector which is represented as comp, then comp=(index2==1)=[0,1,0]. The value in the third vector is ciphertexts.

The third vector comp is extended by m−1 rows to obtain a comparison matrix. Specifically, comp is extended for m−1=1 times by rows to obtain the following comparison matrix comp_T:

$$comp\_T = \{ \begin{matrix}0 & 1 & 0 \\ 0 & 1 & 0\end{matrix} \}$$

The comparison matrix comp_T is multiplied with the sample data matrix with m rows and n columns to obtain a third matrix. For example, comp_T is multiplied with the sample data matrix x in D4(x,y) to obtain the following third matrix B:

$$B = {x}^{*} comp\_T = \{ \begin{matrix}1 & 2 & 3 \\ 4 & 5 & 6\end{matrix} \} * \{ \begin{matrix}0 & 1 & 0 \\ 0 & 1 & 0\end{matrix} \} = \{ \begin{matrix}0 & 2 & 0 \\ 0 & 5 & 0\end{matrix} \}$$

The third matrixes B are added by columns to obtain a column vector corresponding to the optimal feature. Specifically, the following column vector corresponding to the optimal feature is obtained by adding together B by columns:

$$C = \{ \begin{matrix}2 \\ 5\end{matrix} \}$$

Therefore, in the embodiment of the present disclosure, on the basis of ciphertexts, the column vector corresponding to the optimal feature is selected in the sample data matrix.

With the dataset D1(x,y) shown in Table 1 as an example, suppose that the following first matrix M is constructed based on the partition coefficient of each candidate split of D1(x,y):

$$M = \{ \begin{matrix}0.1 & 0.01 \\ 0.02 & 0.03 \\ 0.07 & 0.09\end{matrix} \}$$

and the following second matrix x2 is constructed:

$$x 2 = \{ \begin{matrix}0.5 & 0.7 \\ 5 & 7 \\ 20 & 30\end{matrix} \}$$

Suppose that the ciphertext index s=argmin(M.flatten( ))=0 is obtained through calculating, i.e., the ciphertext index is the ciphertext of “0”, then the target index Iⱼ=s//n=s//3=1, and the optimal splitting value a is:

a=inner(x2·flatten( ),np·arange(3*2)==0)=0.7

Therefore, the optimal feature of the current node is the first feature “arm length”, and the optimal splitting value is the feature value corresponding to the feature “arm length”, i.e., 0.7.

The sample data and sample labels in D1(x,y) are assigned to the two child nodes of the current node based on the optimal feature “arm length” and the optimal splitting value “0.7”. Please refer to Table 2 which shows the sample data and the sample labels contained in the left child node, and please refer to Table 3 which shows the sample data and the sample labels contained in the right child node.

TABLE 2

| Arm length | Age | Weight | Healthiness |
|---|---|---|---|
| 0.5 | 21 | 70 | 0 |
| 0.7 | 5 | 20 | 1 |

TABLE 3

| Arm length | Age | Weight | Healthiness |
|---|---|---|---|
| 0.9 | 7 | 30 | 0 |

In the embodiments of the present disclosure, a method for training a tree model is disclosed, and in the method, a tree model can be trained based on a dataset on the basis of ciphertexts. The feature and feature value in the dataset are ciphertexts, and for the dataset, candidate splits are generated based on the ciphertexts, and the feature in the candidate split whose partition coefficient satisfies preset condition is determined to be the optimal feature, and the threshold in the candidate split whose partition coefficient satisfies a preset condition is determined to be the optimal splitting value, and the optimal feature and the optimal splitting value are also ciphertexts. Through the embodiments of the present disclosure, during the training of the tree model, the data in plaintext in the dataset can not be exposed, and the optimal feature and the optimal splitting value in plaintext can also not be exposed, and the privacy security of the data can be ensured.

It should be noted that the method embodiments are presented as a series of combinations of steps for simplicity of description, but those skilled in the art should be known that the embodiments of the present disclosure are not limited by the sequence of steps described, and some steps may be performed in other sequences or simultaneously according to the embodiments of the present disclosure. In addition, those skilled in the art should also be known that the embodiments described in the specification are preferred embodiments and that the steps described are not the necessary steps required by the embodiments of the present disclosure.

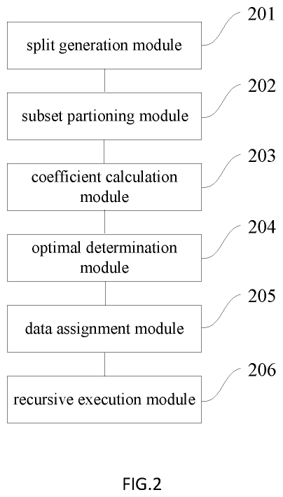

Please refer to FIG. 2, which shows a structural block diagram of an apparatus configured to train a tree model in an embodiment of the present disclosure. The apparatus is used to train the tree model based on a dataset, and wherein the dataset comprises m pieces of sample data and m sample labels, each sample data comprises n features, and wherein the features and feature values in the dataset are ciphertexts, the apparatus comprises: a split generation module 201, configured to generate, for the dataset, candidate splits based on the ciphertexts, wherein each candidate split is consisting of a feature and a threshold corresponding to the feature; a subset partitioning module 202, configured to partition, for each candidate split, the dataset into a left subset and a right subset based on the ciphertexts; a coefficient calculation module 203, configured to calculate a partition coefficient of each candidate split based on the left subset and the right subset obtained through partition for each candidate split; an optimal determination module 204, configured to determine a feature in a target candidate split as an optimal feature, and determine a threshold in the target candidate split as an optimal splitting value, wherein the target candidate split is a candidate split whose partition coefficient satisfies a preset condition, and the optimal feature and the optimal splitting value are ciphertexts; a data assignment module 205, configured to assign the dataset to two child nodes of the current node based on the optimal feature and the optimal splitting value; and a recursive execution module 206, configured to perform the above steps on the two child nodes recursively until a stop condition is satisfied.

In an embodiment, the split generation module 201 includes a sorting submodule and a combination submodule, the sorting submodule is configured to sort, in a preset sorting manner, m feature values corresponding to the j-th feature in the dataset based on the ciphertext to obtain a first array corresponding to the j-th feature, with j taking a value in a range from 0 to n−1; and the combination submodule is configured to select in sequence, for the j-th feature, an element from the first array as a threshold corresponding to the j-th feature, and combining the threshold with the j-th feature to obtain a candidate split.

In an embodiment, the combination submodule is configured to select in sequence an element from the non-maximum elements in the first array as the threshold corresponding to the j-th feature.

In an embodiment, the apparatus further includes a label determination module, configured to determine a second array corresponding to the first array according to the same sorting manner as used in the m feature values corresponding to the j-th feature, wherein the second array comprises each sample label corresponding to each feature value in the first array; and the subset partitioning module is configured to, based on the feature and threshold in each candidate split, partition the m pieces of sample data into the left subset and the right subset and partition the second array to the left subset and the right subset.

In an embodiment, the optimal determination module includes a first matrix construction submodule, a second matrix construction submodule, a first vector transforming submodule, a ciphertex index determination submodule, and an optimal determination submodule. Wherein, the first matrix construction submodule is configured to construct a first matrix with n rows and m−1 columns based on the partition coefficient of each candidate split; the second matrix construction submodule is configured to construct a second matrix with n rows and m−1 columns based on a sorting result of m feature values corresponding to each feature in the dataset; the first vector transforming submodule is configured to transform the first matrix into a first vector; the ciphertex index determination submodule is configured to determine a ciphertext index corresponding to an element whose partition coefficient satisfies the preset condition in the first vector; and the optimal determination submodule is configured to determine the optimal feature based on the ciphertext index, and determine the optimal splitting value based on the ciphertext index and the second matrix.

In an embodiment, the optimal determination submodule includes an index calculation unit and an optimal feature determination unit. Wherein, the index calculation unit is configured to perform an exact division operation on n by utilizing the ciphertext index to obtain a target index of the optimal feature in the n features; and the optimal feature determination unit is configured to determine the optimal feature in the n features according to the target index.

In an embodiment, the optimal determination submodule includes a first sequence construction unit, an index vector construction unit, a second vector transforming unit and an optimal splitting value determination unit. Wherein, the first sequence construction unit is configured to construct a first sequence, wherein the first sequence is a sequence of integers starting from 0 to (m−1)×n; the index vector construction unit is configured to compare the ciphertext index with each element in the first sequence, respectively, to obtain an index vector consisting of the comparison results represented by ciphertexts; the second vector transforming unit is configured to transform rows 0 to m−2 of the second matrix into a second vector; and the optimal splitting value determination unit is configured to perform an inner product operation on the second vector and the index vector to obtain the optimal splitting value.

In an embodiment, the tree model is a CART model, and the data assignment module includes a column vector determination submodule, a result matrix determination submodule, a result matrix transforming submodule and a data assignment submodule. Wherein, the column vector determination submodule is configured to determine a column vector corresponding to the optimal feature in the dataset; the result matrix determination submodule is configured to compare the optimal splitting value with each element in the column vector, respectively, to obtain a result matrix consisting of the comparison results represented by ciphertexts; the result matrix transforming submodule is configured to restore each element in the result matrix to plaintext to obtain a result matrix represented by plaintexts; and the data assignment submodule is configured to assign a sample data corresponding to an element of the first value in the result matrix represented by plaintexts and a sample label corresponding to the sample data to a left node of the current node, and assign a sample data corresponding to an element of the second value in the result matrix represented by plaintexts and a sample label corresponding to the sample data to a right node of the current node.

In an embodiment, the column vector determination submodule includes a second sequence construction unit, a third vector determination unit, a comparison matrix determination unit, a third matrix determination unit and a column vector determination unit. Wherein, the second sequence construction unit is configured to construct a second sequence, wherein the second sequence is a sequence of integers starting from 0 to n−1; the third vector determination unit is configured to compare the ciphertext index with each element in the second sequence, respectively, to obtain a third vector consisting of the comparison results represented by ciphertexts; the comparison matrix determination unit is configured to extend the third vector by m−1 rows to obtain a comparison matrix; the third matrix determination unit is configured to multiply the comparison matrix with a sample data matrix of m rows and n columns to obtain a third matrix; and the column vector determination unit is configured to add together the third matrix by columns to obtain the column vector corresponding to the optimal feature.

In an embodiment, the tree model includes a random forest model, or an XGBoost model.

In an embodiment, the stop condition comprises any one of the following: the depth of a tree model being constructed currently reaches a preset maximum depth, the number of features in the child node is less than a preset minimum number, and all the sample data in the dataset are assigned.

In an embodiment, the partition coefficient is a Gini index, the Gini index is calculated based on an impurity function, and the impurity function comprises a Gini function or an Entropy function.

In the apparatus for training a tree model disclosed in the present application, a tree model can be trained based on a dataset on the basis of ciphertexts. The feature and feature value in the dataset are ciphertexts, and for the dataset, candidate splits are generated based on the ciphertexts, and the feature in the candidate split whose partition coefficient satisfies preset condition is determined to be the optimal feature, and the threshold in the candidate split whose partition coefficient satisfies a preset condition is determined to be the optimal splitting value, and the optimal feature and the optimal splitting value are also ciphertexts. Through the embodiments of the present disclosure, during the training of the tree model, the data in plaintext in the dataset can not be exposed, and the optimal feature and the optimal splitting value in plaintext can also not be exposed, and the privacy security of the data can be ensured.

For the apparatus embodiment, since it is substantially similar to the method embodiment, the description is relatively simple, and for the related part, please refer to the description for the method embodiment.

Each embodiment in the present specification is described in a progressive manner, each embodiment focuses on the differences from the other embodiments, and for the same or similar parts between the various embodiments, please refer to each other.

Regarding the apparatus in the above embodiments, the specific manner in which each module performs its operation has been described in detail in the embodiments of the method, and will not be described in detail herein.

A device for training a tree model is disclosed in the present application. The device is used to train the tree model based on a dataset, and wherein the dataset comprises m pieces of sample data and m sample labels, each sample data comprises n features, and wherein the features and feature values in the dataset are ciphertexts, wherein, the device comprises a memory and one or more programs, the one or more programs is stored in the memory and is configured as by one or more of processors execute, and the one or more programs include an instruction for performing the following steps: generating, for the dataset, candidate splits based on the ciphertexts, wherein each candidate split is consisting of a feature and a threshold corresponding to the feature; partitioning, for each candidate split, the dataset into a left subset and a right subset based on the ciphertexts; calculating a partition coefficient of each candidate split based on the left subset and the right subset obtained through partition for each candidate split; determining a feature in a target candidate split as an optimal feature, and determining a threshold in the target candidate split as an optimal splitting value, wherein the target candidate split is a candidate split whose partition coefficient satisfies a preset condition, and the optimal feature and the optimal splitting value are ciphertexts; assigning the dataset to two child nodes of the current node based on the optimal feature and the optimal splitting value; and performing the above steps on the two child nodes recursively until a stop condition is satisfied.

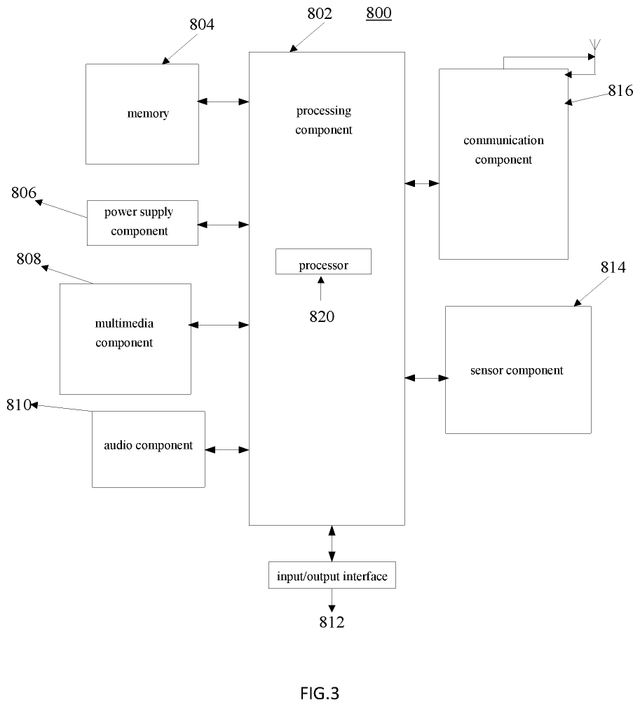

FIG. 3 shows a block diagram of a device 800 configured to train a tree model in an embodiment of the present disclosure. For example, the device 800 may be a mobile phone, a computer, a digital broadcast terminal, a message transceiving device, a game console, a tablet device, a medical device, a fitness device, a personal digital assistant, etc.

Please refer to FIG. 3, the device 800 includes one or more of the following components: a processing component 802, a memory 804, a power supply component 806, a multimedia component 808, an audio component 810, an input/output (I/O) interface 812, a sensor component 814, and a communication component 816.

The processing component 802 typically controls the overall operation of the device 800, such as operations associated with displaying, telephone call, data communication, camera operation, and recording operation. The processing component 802 includes one or more processors 820, the processor is configured execute instructions for performing all or some of the steps of the above method. In addition, the processing component 802 includes one or more modules that is used to interact with other components. For example, the processing component 802 includes a multimedia module which is used to interact with the multimedia component 808.

The memory 804 is configured to store various types of data to support operations on the device 800. Examples of such data include instructions for operating any application or method on the device 800, contact data, phonebook data, messages, pictures, videos, etc. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory disk or CD-ROM.

The power supply component 806 provides power to various components of the device 800. The power supply component 806 includes a power management system, one or more power supplies, and other components for generating, managing, and distributing power for the device 800.

The multimedia component 808 includes a screen that provides an output interface between the device 800 and the user. In some embodiments, the screen includes a liquid crystal display (LCD) and a touch panel (TP). If the screen includes a touch panel, the screen can be implemented as a touch screen to receive input signals from the user. The touch panel includes one or more touch sensors to sense touch, swipe, and gesture on the touch panel. The touch sensor may not only sense the boundary of the touching or swiping action, but also detect the duration and pressure associated with the touching or swiping action. In some embodiments, the multimedia component 808 includes a front-facing camera and/or a rear-facing camera. When the device 800 is in an operating mode, such as an imaging capturing mode or a video mode, the front-facing camera and/or rear-facing camera may receive external multimedia data. Each front-facing camera and rear-facing camera may be a fixed optical lens system or have focal length and optical zoom capability.

The audio component 810 is configured to output and/or input audio signal. For example, the audio component 810 includes a microphone (MIC), when the device 800 is in an operating mode, such as a call mode, a recording mode, and a voice message processing mode, the microphone is configured to receive external audio signal. The received audio signal is stored in the memory 804 or sent via the communication component 816. In some embodiments, the audio component 810 includes a speaker for outputting the audio signals.

The I/O interface 812 provides an interface between the processing component 802 and the peripheral interface module, and the above peripheral interface module is keypad, click wheel, button, etc. This button includes, but is not limited to: a home button, a volume button, a start button, and a lock button.

The sensor component 814 includes one or more sensors configured to provide status assessment of various aspects for the device 800. For example, the sensor component 814 is used to detect an open/closed state of the device 800, the relative position of components, for example, the components is the display and keypad of the device 800, and the sensor component 814 is also used to detect a change in position of the device 800 or a component of the device 800, the presence or absence of contacting between user and the device 800, the orientation of the device 800 or acceleration/deceleration and the temperature change of the device 800. The sensor component 814 may include a proximity sensor configured to detect the presence of a nearby object without any physical contact. The sensor component 814 may also include a light sensor, such as a CMOS or CCD image sensor and is used in imaging applications. In some embodiments, the sensor component 814 may also include an accelerometer sensor, a gyroscope sensor, a magnetic sensor, a pressure sensor, or a temperature sensor.

The communication component 816 is configured to facilitate the communication between the device 800 and other devices through wired or wireless means. The device 800 may access a wireless network based on a communication standard, such as WiFi, 2G or 3G, or a combination thereof. In an exemplary embodiment, the communication component 816 receives broadcast signal or broadcast-related information from an external broadcast management system via a broadcast channel. In an exemplary embodiment, the communication component 816 includes a near-field communication (NFC) module to facilitate short-range communication. For example, the NFC module may be implemented based on the radio frequency information processing (RFID) technology, the infrared data association (IrDA) technology, the ultra-wideband (UWB) technology, the Bluetooth (BT) technology, and other technologies.

In exemplary embodiments, the device 800 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic elements, and is used for performing the above methods.

In exemplary embodiments, a non-transitory computer readable storage medium including instruction is further disclosed, such as a memory 804 including instruction, the above instruction may be executed by the processor 820 of the device 800 to perform the above method. For example, the non-transitory computer readable storage medium may be ROM, random access memory (RAM), CD-ROM, magnetic tape, floppy disk, and optical data storage device, etc.

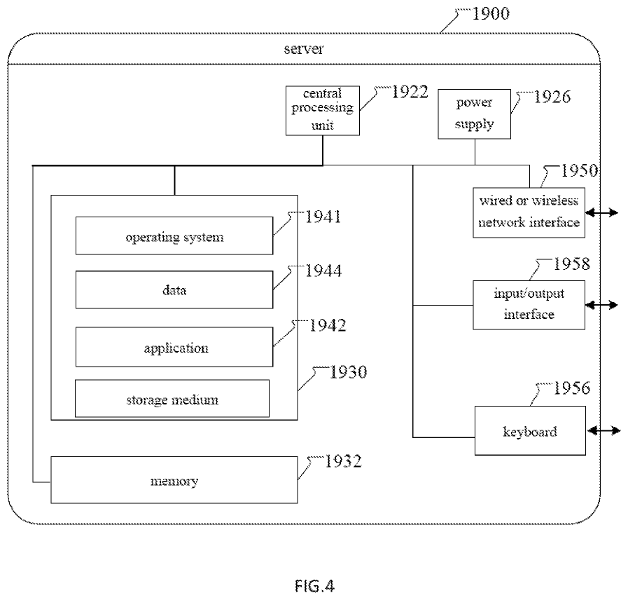

FIG. 4 shows a structural schematic diagram of a server in an embodiment of the present disclosure. The server 1900 may be various due to differences in configuration or performance, and the server includes one or more central processing units (CPUs) 1922 (e.g., one or more processors) and a memory 1932, one or more storage mediums 1930 (e.g., one or more mass storage devices) configured to store application 1942 or data 1944. Wherein, the memory 1932 and the storage medium 1930 may be transient storage or persistent storage. The program stored in the storage medium 1930 may include one or more modules (not shown in the figure), each module includes a series of instruction operations in the server. Further, the central processor 1922 is set to communicate with the storage medium 1930 to execute a series of instruction operations in the storage medium 1930 on the server 1900.

The server 1900 may also include one or more power supplies 1926, one or more wired or wireless network interfaces 1950, one or more input/output interfaces 1958, one or more keyboards 1956, and/or one or more operating systems 1941 such as Windows Server™, Mac OS X™, Unix™, Linux™, FreeBSD™, etc.

A non-transitory computer readable storage medium is disclosed, and when instructions in the storage medium are executed by a processor of a device (a server or a terminal), the device performs the method for training a tree model shown in FIG. 1.

A non-transitory computer readable storage medium is disclosed, and when an instruction stored in the storage medium is executed by one or more of processors in an equipment (server or terminal), a method for training a tree model is performed. The method comprises the following steps: generating, for the dataset, candidate splits based on the ciphertexts, wherein each candidate split is consisting of a feature and a threshold corresponding to the feature; partitioning, for each candidate split, the dataset into a left subset and a right subset based on the ciphertexts; calculating a partition coefficient of each candidate split based on the left subset and the right subset obtained through partition for each candidate split; determining a feature in a target candidate split as an optimal feature, and determining a threshold in the target candidate split as an optimal splitting value, wherein the target candidate split is a candidate split whose partition coefficient satisfies a preset condition, and the optimal feature and the optimal splitting value are ciphertexts; assigning the dataset to two child nodes of the current node based on the optimal feature and the optimal splitting value; and performing the above steps on the two child nodes recursively until a stop condition is satisfied.

Embodiments disclosed in the present application include:

A1. A method for training a tree model, wherein the method is used to train the tree model based on a dataset, and wherein the dataset comprises m pieces of sample data and m sample labels, each sample data comprises n features, and wherein the features and feature values in the dataset are ciphertexts, the method comprises the following steps:

generating, for the dataset, candidate splits based on the ciphertexts, wherein each candidate split is consisting of a feature and a threshold corresponding to the feature;

partitioning, for each candidate split, the dataset into a left subset and a right subset based on the ciphertexts;

calculating a partition coefficient of each candidate split based on the left subset and the right subset obtained through partition for each candidate split;

determining a feature in a target candidate split as an optimal feature, and determining a threshold in the target candidate split as an optimal splitting value, wherein the target candidate split is a candidate split whose partition coefficient satisfies a preset condition, and the optimal feature and the optimal splitting value are ciphertexts;

assigning the dataset to two child nodes of the current node based on the optimal feature and the optimal splitting value; and

performing the above steps on the two child nodes recursively until a stop condition is satisfied.

A2. The method of A1, the step of generating candidate splits based on the ciphertexts comprises the following steps:

sorting, in a preset sorting manner, m feature values corresponding to the j-th feature in the dataset based on the ciphertext to obtain a first array corresponding to the j-th feature, with j taking a value in a range from 0 to n−1; and

selecting in sequence, for the j-th feature, an element from the first array as a threshold corresponding to the j-th feature, and combining the threshold with the j-th feature to obtain a candidate split.

A3. The method of A2, the step of selecting in sequence an element from the first array as a threshold corresponding to the j-th feature comprises:

selecting in sequence an element from the non-maximum elements in the first array as the threshold corresponding to the j-th feature.

A4. The method of A2, after obtaining the first array corresponding to the j-th feature, the method further comprises:

determining a second array corresponding to the first array according to the same sorting manner as used in the m feature values corresponding to the j-th feature, wherein the second array comprises each sample label corresponding to each feature value in the first array;

and the step of partitioning, for each candidate split, the dataset into a left subset and a right subset based on the ciphertexts comprises: based on the feature and threshold in each candidate split, partitioning the m pieces of sample data into the left subset and the right subset and partitioning the second array to the left subset and the right subset.

A5. The method of A1, the step of determining a feature in a target candidate split as an optimal feature, and determining a threshold in the target candidate split as an optimal splitting value comprises the following steps:

constructing a first matrix with n rows and m−1 columns based on the partition coefficient of each candidate split;

constructing a second matrix with n rows and m−1 columns based on a sorting result of m feature values corresponding to each feature in the dataset;

transforming the first matrix into a first vector;

determining a ciphertext index corresponding to an element whose partition coefficient satisfies the preset condition in the first vector; and

determining the optimal feature based on the ciphertext index, and determining the optimal splitting value based on the ciphertext index and the second matrix.

A6. The method of A5, the step of determining the optimal feature based on the ciphertext index comprises:

performing an exact division operation on n by utilizing the ciphertext index to obtain a target index of the optimal feature in the n features; and

determining the optimal feature in the n features according to the target index.

A7. The method of A5, the step of determining the optimal splitting value based on the ciphertext index and the second matrix comprises:

constructing a first sequence, wherein the first sequence is a sequence of integers starting from 0 to (m−1)×n;

comparing the ciphertext index with each element in the first sequence, respectively, to obtain an index vector consisting of the comparison results represented by ciphertexts;

transforming rows 0 to m−2 of the second matrix into a second vector; and

performing an inner product operation on the second vector and the index vector to obtain the optimal splitting value.

A8. The method of A1, the tree model is a CART model, and the step of assigning the dataset to two child nodes of the current node based on the optimal feature and the optimal splitting value comprises the following steps:

determining a column vector corresponding to the optimal feature in the dataset;

comparing the optimal splitting value with each element in the column vector, respectively, to obtain a result matrix consisting of the comparison results represented by ciphertexts;

restoring each element in the result matrix to plaintext to obtain a result matrix represented by plaintexts; and

assigning a sample data corresponding to an element of the first value in the result matrix represented by plaintexts and a sample label corresponding to the sample data to a left node of the current node, and assigning a sample data corresponding to an element of the second value in the result matrix represented by plaintexts and a sample label corresponding to the sample data to a right node of the current node.

A9. The method of A8, the step of determining a column vector corresponding to the optimal feature in the dataset comprises:

constructing a second sequence, wherein the second sequence is a sequence of integers starting from 0 to n−1;

comparing the ciphertext index with each element in the second sequence, respectively, to obtain a third vector consisting of the comparison results represented by ciphertexts;

extending the third vector by m−1 rows to obtain a comparison matrix;

multiplying the comparison matrix with a sample data matrix of m rows and n columns to obtain a third matrix; and

adding together the third matrix by columns to obtain the column vector corresponding to the optimal feature.

A10. The method of A1, the tree model comprises a random forest model, or an XGBoost model.

A11. The method of any one of A1-A10, the stop condition comprises any one of the following: the depth of a tree model being constructed currently reaches a preset maximum depth, the number of features in the child node is less than a preset minimum number, and all the sample data in the dataset are assigned.

A12. The method of any one of A1-A10, the partition coefficient is a Gini index, the Gini index is calculated based on an impurity function, and the impurity function comprises a Gini function or an Entropy function.

Further embodiments disclosed in the present application include:

B13. An apparatus configured to train a tree model, the apparatus is used to train the tree model based on a dataset, and wherein the dataset comprises m pieces of sample data and m sample labels, each sample data comprises n features, and wherein the features and feature values in the dataset are ciphertexts, the apparatus comprises:

a split generation module, configured to generate, for the dataset, candidate splits based on the ciphertexts, wherein each candidate split is consisting of a feature and a threshold corresponding to the feature;

a subset partitioning module, configured to partition, for each candidate split, the dataset into a left subset and a right subset based on the ciphertexts;

a coefficient calculation module, configured to calculate a partition coefficient of each candidate split based on the left subset and the right subset obtained through partition for each candidate split;

an optimal determination module, configured to determine a feature in a target candidate split as an optimal feature, and determine a threshold in the target candidate split as an optimal splitting value, wherein the target candidate split is a candidate split whose partition coefficient satisfies a preset condition, and the optimal feature and the optimal splitting value are ciphertexts;

a data assignment module, configured to assign the dataset to two child nodes of the current node based on the optimal feature and the optimal splitting value; and

a recursive execution module, configured to perform the above steps on the two child nodes recursively until a stop condition is satisfied.

B14. The apparatus of B13, the split generation module comprises:

a sorting submodule, configured to sort, in a preset sorting manner, m feature values corresponding to the j-th feature in the dataset based on the ciphertext to obtain a first array corresponding to the j-th feature, with j taking a value in a range from 0 to n−1; and

a combination submodule is configured to select in sequence, for the j-th feature, an element from the first array as a threshold corresponding to the j-th feature, and combining the threshold with the j-th feature to obtain a candidate split.

B15. The apparatus of B14, the combination submodule is configured to select in sequence an element from the non-maximum elements in the first array as the threshold corresponding to the j-th feature.

B16. The apparatus of B14, the apparatus further comprises:

a label determination module, configured to determine a second array corresponding to the first array according to the same sorting manner as used in the m feature values corresponding to the j-th feature, wherein the second array comprises each sample label corresponding to each feature value in the first array; and

the subset partitioning module is configured to, based on the feature and threshold in each candidate split, partition the m pieces of sample data into the left subset and the right subset and partition the second array to the left subsetand the right subset.

B17. The apparatus of B13, the optimal determination module comprises:

a first matrix construction submodule, configured to construct a first matrix with n rows and m−1 columns based on the partition coefficient of each candidate split;

a second matrix construction submodule, configured to construct a second matrix with n rows and m−1 columns based on a sorting result of m feature values corresponding to each feature in the dataset;

a first vector transforming submodule, configured to transform the first matrix into a first vector;

a ciphertex index determination submodule, configured to determine a ciphertext index corresponding to an element whose partition coefficient satisfies the preset condition in the first vector; and

an optimal determination submodule, configured to determine the optimal feature based on the ciphertext index, and determine the optimal splitting value based on the ciphertext index and the second matrix.

B18. The apparatus of B17, the optimal determination submodule comprises:

an index calculation unit, configured to perform an exact division operation on n by utilizing the ciphertext index to obtain a target index of the optimal feature in the n features; and

an optimal feature determination unit, configured to determine the optimal feature in the n features according to the target index.

B19. The apparatus of B17, the optimal determination submodule comprises:

a first sequence construction unit, configured to construct a first sequence, wherein the first sequence is a sequence of integers starting from 0 to (m−1)×n;

an index vector construction unit, configured to compare the ciphertext index with each element in the first sequence, respectively, to obtain an index vector consisting of the comparison results represented by ciphertexts;

a second vector transforming unit, configured to transform rows 0 to m−2 of the second matrix into a second vector; and

an optimal splitting value determination unit, configured to perform an inner product operation on the second vector and the index vector to obtain the optimal splitting value.

B20. The apparatus of B13, the tree model is a CART model, and the data assignment module comprises:

a column vector determination submodule, configured to determine a column vector corresponding to the optimal feature in the dataset;

a result matrix determination submodule, configured to compare the optimal splitting value with each element in the column vector, respectively, to obtain a result matrix consisting of the comparison results represented by ciphertexts;

a result matrix transforming submodule, configured to restore each element in the result matrix to plaintext to obtain a result matrix represented by plaintexts; and

a data assignment submodule, configured to assign a sample data corresponding to an element of the first value in the result matrix represented by plaintexts and a sample label corresponding to the sample data to a left node of the current node, and assign a sample data corresponding to an element of the second value in the result matrix represented by plaintexts and a sample label corresponding to the sample data to a right node of the current node.

B21. The apparatus of B20, the column vector determination submodule comprises:

a second sequence construction unit, configured to construct a second sequence, wherein the second sequence is a sequence of integers starting from 0 to n−1;

a third vector determination unit, configured to compare the ciphertext index with each element in the second sequence, respectively, to obtain a third vector consisting of the comparison results represented by ciphertexts;

a comparison matrix determination unit, configured to extend the third vector by m−1 rows to obtain a comparison matrix;

a third matrix determination unit, configured to multiply the comparison matrix with a sample data matrix of m rows and n columns to obtain a third matrix; and

a column vector determination unit, configured to add together the third matrix by columns to obtain the column vector corresponding to the optimal feature.

B22. The apparatus of B13, the tree model comprises a random forest model, or an XGBoost model.

B23. The apparatus of any of B13-B22, the stop condition comprises any one of the following: the depth of a tree model being constructed currently reaches a preset maximum depth, the number of features in the child node is less than a preset minimum number, and all the sample data in the dataset are assigned.

B24. The apparatus of any of B13-B22, the partition coefficient is a Gini index, the Gini index is calculated based on an impurity function, and the impurity function comprises a Gini function or an Entropy function.

Further embodiments disclosed in the present application include:

C25. A device for training a tree model, wherein the device is used to train the tree model based on a dataset, and wherein the dataset comprises m pieces of sample data and m sample labels, each sample data comprises n features, and wherein the features and feature values in the dataset are ciphertexts, wherein, the device comprises a memory and one or more programs, the one or more programs is stored in the memory and is configured as by one or more of processors execute, and the one or more programs include an instruction for performing the following steps:

generating, for the dataset, candidate splits based on the ciphertexts, wherein each candidate split is consisting of a feature and a threshold corresponding to the feature;

partitioning, for each candidate split, the dataset into a left subset and a right subset based on the ciphertexts;

calculating a partition coefficient of each candidate split based on the left subset and the right subset obtained through partition for each candidate split;

determining a feature in a target candidate split as an optimal feature, and determining a threshold in the target candidate split as an optimal splitting value, wherein the target candidate split is a candidate split whose partition coefficient satisfies a preset condition, and the optimal feature and the optimal splitting value are ciphertexts;

assigning the dataset to two child nodes of the current node based on the optimal feature and the optimal splitting value; and

performing the above steps on the two child nodes recursively until a stop condition is satisfied.

C26. The device of C25, the step of generating candidate splits based on the ciphertexts comprises the following steps:

sorting, in a preset sorting manner, m feature values corresponding to the j-th feature in the dataset based on the ciphertext to obtain a first array corresponding to the j-th feature, with j taking a value in a range from 0 to n−1; and

selecting in sequence, for the j-th feature, an element from the first array as a threshold corresponding to the j-th feature, and combining the threshold with the j-th feature to obtain a candidate split.

C27. The device of C26, the step of selecting in sequence an element from the first array as a threshold corresponding to the j-th feature comprises:

selecting in sequence an element from the non-maximum elements in the first array as the threshold corresponding to the j-th feature.

C28. The device of C26, the one or more programs further include an instruction for performing the following steps:

determining a second array corresponding to the first array according to the same sorting manner as used in the m feature values corresponding to the j-th feature, wherein the second array comprises each sample label corresponding to each feature value in the first array;

and the step of partitioning, for each candidate split, the dataset into a left subset and a right subset based on the ciphertexts comprises: based on the feature and threshold in each candidate split, partitioning the m pieces of sample data into the left subset and the right subset and partitioning the second array to the left subset and the right subset.

C29. The device of C25, the step of determining a feature in a target candidate split as an optimal feature, and determining a threshold in the target candidate split as an optimal splitting value comprises the following steps:

constructing a first matrix with n rows and m−1 columns based on the partition coefficient of each candidate split;

constructing a second matrix with n rows and m−1 columns based on a sorting result of m feature values corresponding to each feature in the dataset;

transforming the first matrix into a first vector;

determining a ciphertext index corresponding to an element whose partition coefficient satisfies the preset condition in the first vector; and

determining the optimal feature based on the ciphertext index, and determining the optimal splitting value based on the ciphertext index and the second matrix.

C30. The device of C29, the step of determining the optimal feature based on the ciphertext index comprises:

performing an exact division operation on n by utilizing the ciphertext index to obtain a target index of the optimal feature in the n features; and

determining the optimal feature in the n features according to the target index.

C31. The device of C29, the step of determining the optimal splitting value based on the ciphertext index and the second matrix comprises:

constructing a first sequence, wherein the first sequence is a sequence of integers starting from 0 to (m−1)×n;

comparing the ciphertext index with each element in the first sequence, respectively, to obtain an index vector consisting of the comparison results represented by ciphertexts;

transforming rows 0 to m−2 of the second matrix into a second vector; and performing an inner product operation on the second vector and the index vector to obtain the optimal splitting value.

C32. The device of C25, the tree model is a CART model, and the step of assigning the dataset to two child nodes of the current node based on the optimal feature and the optimal splitting value comprises the following steps:

determining a column vector corresponding to the optimal feature in the dataset;

comparing the optimal splitting value with each element in the column vector, respectively, to obtain a result matrix consisting of the comparison results represented by ciphertexts;

restoring each element in the result matrix to plaintext to obtain a result matrix represented by plaintexts; and

assigning a sample data corresponding to an element of the first value in the result matrix represented by plaintexts and a sample label corresponding to the sample data to a left node of the current node, and assigning a sample data corresponding to an element of the second value in the result matrix represented by plaintexts and a sample label corresponding to the sample data to a right node of the current node.

C33. The device of C32, the step of determining a column vector corresponding to the optimal feature in the dataset comprises:

constructing a second sequence, wherein the second sequence is a sequence of integers starting from 0 to n−1;

comparing the ciphertext index with each element in the second sequence, respectively, to obtain a third vector consisting of the comparison results represented by ciphertexts;

extending the third vector by m−1 rows to obtain a comparison matrix;

multiplying the comparison matrix with a sample data matrix of m rows and n columns to obtain a third matrix; and

adding together the third matrix by columns to obtain the column vector corresponding to the optimal feature.

C34. The device of C25, the tree model comprises a random forest model, or an XGBoost model.

C35. The device of any of C25-C34, the stop condition comprises any one of the following: the depth of a tree model being constructed currently reaches a preset maximum depth, the number of features in the child node is less than a preset minimum number, and all the sample data in the dataset are assigned.

C36. The device of any of C25-C34, the partition coefficient is a Gini index, the Gini index is calculated based on an impurity function, and the impurity function comprises a Gini function or an Entropy function.

Further embodiments disclosed in the present application include:

D37. A computer readable storage medium, wherein, an instruction is stored in the storage medium and is configured as by one or more of processors execute for performing the method for training a tree model of any one of A1-A12.

Those skilled in the art will easily think of other embodiments of the present disclosure after consideration of the specification and implementation of the present disclosure disclosed herein. The present disclosure covers any variation, use, or modification of the present disclosure, these variation, use, or modification follows the general principles of the present disclosure and includes common knowledge in the art not disclosed herein. The specification and embodiments are merely exemplary, and the scope and spirit of the present disclosure are indicated by the claims.

It should be noted that the present disclosure is not limited to the precise structure described above and illustrated in the accompanying drawings, and that various modifications and changes may be made without departing from its scope. The scope of the present disclosure is limited only by the appended claims.

What is described above is merely embodiments of the present disclosure and is not intended to limit the present disclosure. Any modification, equivalent substitution and improvement made within the spirit and principles of the present disclosure shall all be included in the protection scope of the present disclosure.

A brief introduction is given above on a method for training a tree model, a device for training a tree model, and a device configured to train a tree model provided in the present disclosure, and specific examples are shown in the text to elaborate the principles and embodiments of the present disclosure. The description of the above examples is merely used to help understanding the method of the present disclosure and its core ideas; for those skilled in the art, the specific embodiments and the scope of application can be changed based on the idea of the present disclosure, thus, the content of the present specification should not be understood as a limitation to the present disclosure.

### OTHER EMBODIMENTS

A number of embodiments have been described. Nevertheless, it will be understood that various modifications may be made without departing from the spirit and scope of the disclosure.

Accordingly, other embodiments are within the scope of the following claims.

What is claimed is:

1. A method for training a tree model, wherein the method is used to train the tree model based on a dataset, and wherein the dataset comprises m pieces of sample data and m sample labels, each sample data comprising n features, and wherein the features and feature values in the dataset are ciphertexts, the method comprising the following steps:
generating, for the dataset, candidate splits based on the ciphertexts, wherein each candidate split is consisting of a feature and a threshold corresponding to the feature;
partitioning, for each candidate split, the dataset into a left subset and a right subset based on the ciphertexts;
calculating a partition coefficient of each candidate split based on the left subset and the right subset obtained through partition for each candidate split;
determining a feature in a target candidate split as an optimal feature, and determining a threshold in the target candidate split as an optimal splitting value, wherein the target candidate split is a candidate split whose partition coefficient satisfies a preset condition, and the optimal feature and the optimal splitting value are ciphertexts;
assigning the dataset to two child nodes of the current node based on the optimal feature and the optimal splitting value; and
performing the above steps on the two child nodes recursively until a stop condition is satisfied.

2. The method of claim 1, wherein, the step of generating candidate splits based on the ciphertexts comprises the following steps:
sorting, in a preset sorting manner, m feature values corresponding to the j-th feature in the dataset based on the ciphertext to obtain a first array corresponding to the j-th feature, with j taking a value in a range from 0 to n−1; and
selecting in sequence, for the j-th feature, an element from the first array as a threshold corresponding to the j-th feature, and combining the threshold with the j-th feature to obtain a candidate split.

3. The method of claim 2, wherein, the step of selecting in sequence an element from the first array as a threshold corresponding to the j-th feature comprises:
selecting in sequence an element from the non-maximum elements in the first array as the threshold corresponding to the j-th feature.

4. The method of claim 2, wherein, after obtaining the first array corresponding to the j-th feature, the method further comprises:
determining a second array corresponding to the first array according to the same sorting manner as used in the m feature values corresponding to the j-th feature, wherein the second array comprises each sample label corresponding to each feature value in the first array;
and the step of partitioning, for each candidate split, the dataset into a left subset and a right subset based on the ciphertexts comprises: based on the feature and threshold in each candidate split, partitioning the m pieces of sample data into the left subset and the right subset and partitioning the second array to the left subset and the right subset.

5. The method of claim 1, wherein, the step of determining a feature in a target candidate split as an optimal feature, and determining a threshold in the target candidate split as an optimal splitting value comprises the following steps:
constructing a first matrix with n rows and m−1 columns based on the partition coefficient of each candidate split;
constructing a second matrix with n rows and m−1 columns based on a sorting result of m feature values corresponding to each feature in the dataset;
transforming the first matrix into a first vector;
determining a ciphertext index corresponding to an element whose partition coefficient satisfies the preset condition in the first vector; and
determining the optimal feature based on the ciphertext index, and determining the optimal splitting value based on the ciphertext index and the second matrix.

6. The method of claim 5, wherein, the step of determining the optimal feature based on the ciphertext index comprises:
performing an exact division operation on n by utilizing the ciphertext index to obtain a target index of the optimal feature in the n features; and
determining the optimal feature in the n features according to the target index.

7. The method of claim 5, wherein, the step of determining the optimal splitting value based on the ciphertext index and the second matrix comprises:
constructing a first sequence, wherein the first sequence is a sequence of integers starting from 0 to (m−1)×n;
comparing the ciphertext index with each element in the first sequence, respectively, to obtain an index vector consisting of the comparison results represented by ciphertexts;
transforming rows 0 to m−2 of the second matrix into a second vector; and
performing an inner product operation on the second vector and the index vector to obtain the optimal splitting value.

8. The method of claim 1, wherein, the tree model is a CART model, and the step of assigning the dataset to two child nodes of the current node based on the optimal feature and the optimal splitting value comprises the following steps:
determining a column vector corresponding to the optimal feature in the dataset;
comparing the optimal splitting value with each element in the column vector, respectively, to obtain a result matrix consisting of the comparison results represented by ciphertexts;
restoring each element in the result matrix to plaintext to obtain a result matrix represented by plaintexts; and
assigning a sample data corresponding to an element of the first value in the result matrix represented by plaintexts and a sample label corresponding to the sample data to a left node of the current node, and assigning a sample data corresponding to an element of the second value in the result matrix represented by plaintexts and a sample label corresponding to the sample data to a right node of the current node.

9. The method of claim 8, wherein, the step of determining a column vector corresponding to the optimal feature in the dataset comprises:
constructing a second sequence, wherein the second sequence is a sequence of integers starting from 0 to n−1;
comparing the ciphertext index with each element in the second sequence, respectively, to obtain a third vector consisting of the comparison results represented by ciphertexts;
extending the third vector by m−1 rows to obtain a comparison matrix;
multiplying the comparison matrix with a sample data matrix of m rows and n columns to obtain a third matrix; and
adding together the third matrix by columns to obtain the column vector corresponding to the optimal feature.

10. The method of claim 1, wherein, the stop condition comprises any one of the following: the depth of a tree model being constructed currently reaches a preset maximum depth, the number of features in the child node is less than a preset minimum number, and all the sample data in the dataset are assigned.

11. The method of claim 1, wherein, the partition coefficient is a Gini index, the Gini index is calculated based on an impurity function, and the impurity function comprises a Gini function or an Entropy function.

12. A device for training a tree model, wherein the device is used to train the tree model based on a dataset, and wherein the dataset comprises m pieces of sample data and m sample labels, each sample data comprising n features, and wherein the features and feature values in the dataset are ciphertexts, wherein, the device comprises a memory and one or more programs, the one or more programs be stored in the memory and be configured as by one or more of processors execute, and the one or more programs include an instruction for performing the following steps:
generating, for the dataset, candidate splits based on the ciphertexts, wherein each candidate split is consisting of a feature and a threshold corresponding to the feature;
partitioning, for each candidate split, the dataset into a left subset and a right subset based on the ciphertexts;
calculating a partition coefficient of each candidate split based on the left subset and the right subset obtained through partition for each candidate split;
determining a feature in a target candidate split as an optimal feature, and determining a threshold in the target candidate split as an optimal splitting value, wherein the target candidate split is a candidate split whose partition coefficient satisfies a preset condition, and the optimal feature and the optimal splitting value are ciphertexts;
assigning the dataset to two child nodes of the current node based on the optimal feature and the optimal splitting value; and
performing the above steps on the two child nodes recursively until a stop condition is satisfied.

13. The device of claim 12, wherein, the step of generating candidate splits based on the ciphertexts comprises the following steps:
sorting, in a preset sorting manner, m feature values corresponding to the j-th feature in the dataset based on the ciphertext to obtain a first array corresponding to the j-th feature, with j taking a value in a range from 0 to n−1; and
selecting in sequence, for the j-th feature, an element from the first array as a threshold corresponding to the j-th feature, and combining the threshold with the j-th feature to obtain a candidate split.

14. The device of claim 13, wherein, the one or more programs further include an instruction for performing the following steps:
determining a second array corresponding to the first array according to the same sorting manner as used in the m feature values corresponding to the j-th feature, wherein the second array comprises each sample label corresponding to each feature value in the first array;
and the step of partitioning, for each candidate split, the dataset into a left subset and a right subset based on the ciphertexts comprises: based on the feature and threshold in each candidate split, partitioning the m pieces of sample data into the left subset and the right subset and partitioning the second array to the left subset and the right subset.

15. The device of claim 12, wherein, the step of determining a feature in a target candidate split as an optimal feature, and determining a threshold in the target candidate split as an optimal splitting value comprises the following steps:
constructing a first matrix with n rows and m−1 columns based on the partition coefficient of each candidate split;
constructing a second matrix with n rows and m−1 columns based on a sorting result of m feature values corresponding to each feature in the dataset;
transforming the first matrix into a first vector;
determining a ciphertext index corresponding to an element whose partition coefficient satisfies the preset condition in the first vector; and
determining the optimal feature based on the ciphertext index, and determining the optimal splitting value based on the ciphertext index and the second matrix.

16. The device of claim 15, wherein, the step of determining the optimal feature based on the ciphertext index comprises:
performing an exact division operation on n by utilizing the ciphertext index to obtain a target index of the optimal feature in the n features; and
determining the optimal feature in the n features according to the target index.

17. The device of claim 15, wherein, the step of determining the optimal splitting value based on the ciphertext index and the second matrix comprises:
constructing a first sequence, wherein the first sequence is a sequence of integers starting from 0 to (m−1)×n;
comparing the ciphertext index with each element in the first sequence, respectively, to obtain an index vector consisting of the comparison results represented by ciphertexts;
transforming rows 0 to m−2 of the second matrix into a second vector; and
performing an inner product operation on the second vector and the index vector to obtain the optimal splitting value.

18. The device of claim 12, wherein, the tree model is a CART model, and the step of assigning the dataset to two child nodes of the current node based on the optimal feature and the optimal splitting value comprises the following steps:
determining a column vector corresponding to the optimal feature in the dataset;
comparing the optimal splitting value with each element in the column vector, respectively, to obtain a result matrix consisting of the comparison results represented by ciphertexts;
restoring each element in the result matrix to plaintext to obtain a result matrix represented by plaintexts; and
assigning a sample data corresponding to an element of the first value in the result matrix represented by plaintexts and a sample label corresponding to the sample data to a left node of the current node, and assigning a sample data corresponding to an element of the second value in the result matrix represented by plaintexts and a sample label corresponding to the sample data to a right node of the current node.

19. The device of claim 18, wherein, the step of determining a column vector corresponding to the optimal feature in the dataset comprises:
constructing a second sequence, wherein the second sequence is a sequence of integers starting from 0 to n−1;
comparing the ciphertext index with each element in the second sequence, respectively, to obtain a third vector consisting of the comparison results represented by ciphertexts;
extending the third vector by m−1 rows to obtain a comparison matrix;
multiplying the comparison matrix with a sample data matrix of m rows and n columns to obtain a third matrix; and
adding together the third matrix by columns to obtain the column vector corresponding to the optimal feature.

20. A computer readable storage medium, an instruction be stored in the storage medium and be configured as by one or more of processors execute for performing a method for training a tree model, wherein, the method is used to train the tree model based on a dataset, and wherein the dataset comprises m pieces of sample data and m sample labels, each sample data comprising n features, and wherein the features and feature values in the dataset are ciphertexts, the method comprising the following steps:
generating, for the dataset, candidate splits based on the ciphertexts, wherein each candidate split is consisting of a feature and a threshold corresponding to the feature;
partitioning, for each candidate split, the dataset into a left subset and a right subset based on the ciphertexts;
calculating a partition coefficient of each candidate split based on the left subset and the right subset obtained through partition for each candidate split;
determining a feature in a target candidate split as an optimal feature, and determining a threshold in the target candidate split as an optimal splitting value, wherein the target candidate split is a candidate split whose partition coefficient satisfies a preset condition, and the optimal feature and the optimal splitting value are ciphertexts;
assigning the dataset to two child nodes of the current node based on the optimal feature and the optimal splitting value; and
performing the above steps on the two child nodes recursively until a stop condition is satisfied.
